(19) United States
(12) Patent Application Publication
(10) Pub. No.: US 2009/0059243 A1
(43) Pub. Date: Mar. 5, 2009

(54) Method for determining the absolute thickness of non-transparent and transparent samples by means of confocal measurement technology

(76) Inventor: Mark A. Weber, Moers (DE)

Correspondence Address: COLLARD & ROE, P.C., 1077 NORTHERN BOULEVARD, ROSLYN, NY, 11576, US

(21) Appl. No.: 11/920,292

(22) PCT Filed: May 11, 2006
(86) PCT No.: PCT/DE2006/000806

§ 371 Date: Nov. 13, 2007

(30) Foreign Application Priority Data
May 12, 2005 (DE) 10 2005 022 819.4

(51) Int. Cl. G01B 11/06

(52) U.S. Cl. 356/630

(57) ABSTRACT

The invention relates to a method for determining the absolute spatially resolved double-sided topography and thickness of specimens using two opposite confocally working microscopes. After the unit has been calibrated, the topography of the specimen is measured on both sides of the specimen, is added and the calibration plane is subtracted. The invention also relates to a device for carrying out the method.

The method described here serves for highly precise determination of the absolute layer thickness of samples. In this connection, the thickness of both transparent and non-transparent samples can be determined directly, with the height resolution that is usual for confocal microscopes. This is made possible by means of a fully automated calibration of the system, without the use of reference normals. This calibration takes less than one minute and can therefore be carried out at short intervals, even in industrial use.

In the case of previously known methods, samples that are lying on a planar surface can be measured, and a thickness can be calculated by way of the measured height. A disadvantage for this method is the possibility of the occurrence of domed formations on the underside of the sample, and the great influence of errors during mounting of the sample on the measurement result.

In other previously known methods, the layer thickness of transparent layers can be determined by way of optical transmitted light methods, for example, but a precise knowledge of the index of refraction and of the usable numerical aperture of the lens being used is required for this purpose. Nevertheless, problems in the evaluation can sometimes occur, which lead to incorrect results. The method described here does not utilize the transparency of layers, but rather is based on measuring the sample surface from two opposite sides. In this method, due to the thermal expansion effect, regular calibration to a reference thickness is required, utilizing the linearity of the measurement heads. Here, a new method for calibrating to a reference thickness, without using reference samples, is described. By means of this method, it is possible to determine the absolute thickness of samples having up to almost twice the thickness of the measurement range of a single microscope, with a resolution accurate to nanometers. In this case, the measurement range amounts to 250 μm and 500 μm, respectively, for example, leading to a maximally measurable sample thickness of almost 0.5 and 1 mm, respectively.

The figures show:

FIG. 1) fundamental diagram concerning the method of operation of the confocal measurement technique,

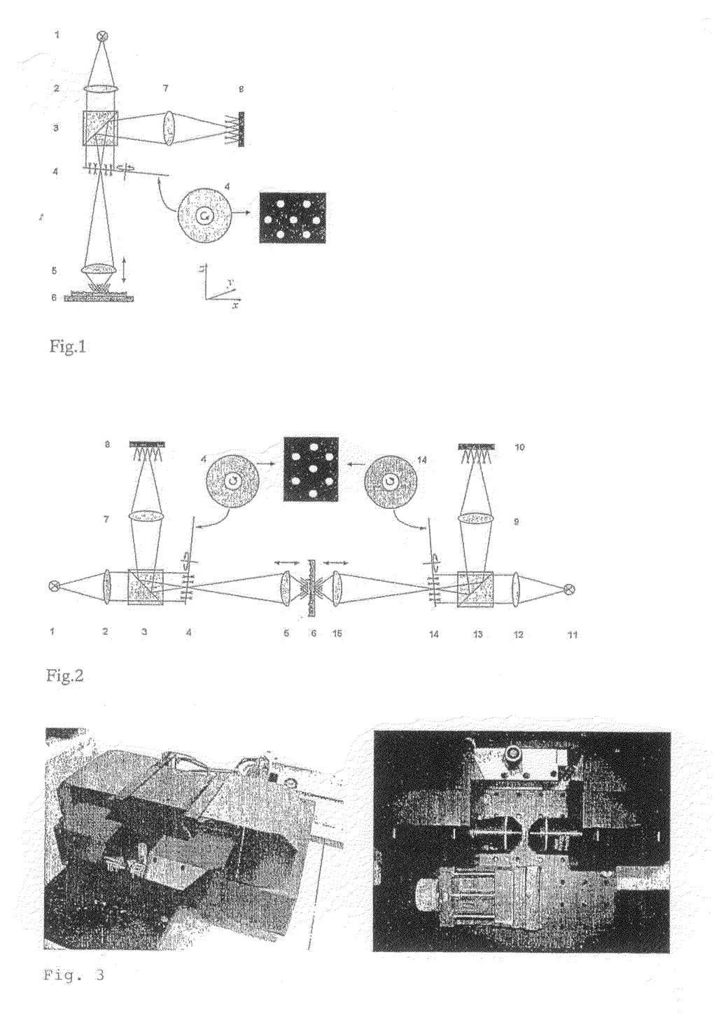

FIG. 2) fundamental diagram of the confocal dual microscope for determining the sample thickness,

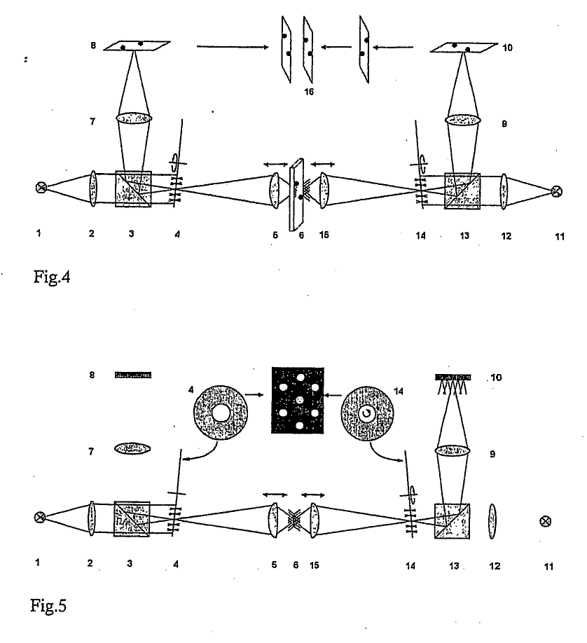

FIG. 3) measurement set-up of the confocal dual microscope for determining the sample thickness,

FIG. 4) fundamental diagram concerning carrying out the lateral calibration by means of a thin reference sample,

FIG. 5) fundamental diagram concerning carrying out the thickness calibration, without a reference sample.

FIG. 1 shows the usual beam path. Here, the light source (1) illuminates the Nipkow disk (4) situated in the intermediate image plane, by way of a lens system (2) and a beam splitter (3). This disk contains a large number of closely adjacent pinholes. The pinholes are imaged on the sample surface by means of lens (5), in refraction-limited manner, from where the reflection is imaged on the same pinholes by way of the same lens. The light transmitted through the pinholes is imaged on the CCD camera chip (8) by way of imaging optics (7). During the measurement, the Nipkow disk rotates, so that the CCD camera always takes a planar confocal microscope picture. The lens (5) is moved vertically (z direction) in a linear movement, by way of a micro-adjuster, while the measurement computer stores the image sequence of the CCD camera, and subsequently evaluates it. An algorithm calculates the z position of the intensity maximum for every pixel, which position is defined as the position of the surface to be measured.

FIG. 2 shows the measurement principle for determining thickness by means of two identical confocal microscopes that function according to FIG. 1. The two microscopes have separate control electronics and are controlled by means of a common measurement computer. The left microscope, having the designations from FIG. 1, measures the left sample surface (6). Subsequently, the right microscope (components 9-15) measures the right sample surface. Subsequently, the measured topographies are added up, and the measured thickness of an infinitesimally thin sample is subtracted. The result is the absolute thickness of the measured sample.

FIG. 3 shows the technical implementation of the measurement principle from FIG. 2, whereby the total system is shown on the left, and the region of the lens/sample is shown on the right.

FIG. 4 shows the principle for calibration of the lateral image sections of the two microscopes relative to one another, using the reference symbols from FIG. 2. Using a transparent, thin sample (6), for example a small cover glass plate having a thickness of 170 μm, the position of the camera image fields relative to one another can be adjusted using characteristic locations. For this purpose, a measurement of the same surface is carried out from both sides. If one considers characteristic points, these must be situated at the same location in the image. Possible deviations can be adjusted by means of suitable displacement, rotation, and a change in the imaging scale relative to one another. The parameters found in this manner are used in every subsequent measurement. This calibration only has to be carried out during a new set-up and as needed; the accuracy of the parameters determined should be checked regularly.

FIG. 5 shows the functional principle for calibration of the thickness measurement of thin samples. Using the reference symbols from FIG. 2, light is transmitted from one microscope into the other, in each instance, with the Nipkow disk standing, in order to coordinate the focal planes in the confocal mode. The second microscope measures the vertical position of the maximal intensity. From this, a virtual topography is obtained, which is interpreted as the position of the focal plane. After this measurement, a control measurement takes place, in which the illumination microscope and the measurement microscope are interchanged.

Settings: To carry out the measurement, the piezo position (5) of head 1 is first set to a value of about 50 μm, whereby the position 0 μm is the position that lies closest to the other measurement head, in each instance. Afterwards, the measurement head 2 carries out a measurement, whereby its light source (11) is shut off and the Nipkow disk (14) rotates. In the evaluation, only points whose intensity is very high are taken into consideration, i.e. only the points illuminated by the opposite microscope are evaluated. A mapping of the superimposition of the focal planes is therefore obtained. The infinitesimally thin sample is simulated by means of this measurement principle. A counter-trial can be carried out, in that the same procedure is carried out with reverse mirror symmetry. In this connection, the Nipkow disk (14) of the right measurement head is therefore stopped, and illuminated by the light source (11), while the confocal image stack is recorded during scanning by the left lens (5), by way of the rotating Nipkow disk (4) of the left measurement head, by means of the CCD camera (4). The average height difference and the inclines in the x and y direction are calculated from the results, in each instance. Proceeding from a correct basic calibration, the results should be identical, within the framework of the measurement accuracy of the individual microscopes. In this manner, the thickness determination by means of the measurement machine can be calibrated in simple manner, which can be automated, without any additional materials. In this manner, the accuracy of the individual measurement devices can be transferred to the thickness measurement with both measurement devices.

1: Method for determining the absolute, spatially resolved, double-sided topography and thickness of samples, by means of two confocally operating microscopes disposed opposite one another, symmetrical to the sample, whereby first, one of the microscopes measures the sample surface that faces it, the second microscope measures the sample surface that faces it, whereupon the measured topographies are added up in a measurement computer, and the thickness of an infinitesimally thin sample is subtracted out.

2: Method according to claim 1, wherein the two measurements are carried out one after the other.

3: Method according to claim 1, wherein a calibration of the lateral image sections of the two microscopes and a thickness calibration are carried out before the actual measurement.

4: Method according to claim 3, wherein a transparent, thin sample is used for calibration of the lateral image sections of the two microscopes relative to one another, which sample has characteristic locations that must agree with one another after the same surface has been measured from both sides, in each instance.

5: Method according to claim 3, wherein in order to calibrate the thickness measurement, for coordination of the focal planes, light is transmitted from one microscope into the other, in each instance, whereby the second microscope measures the vertical position of the maximal intensity, after which the illumination microscope and measurement microscope are interchanged as a control measurement.

6: Device for carrying out the method according to claim 1, wherein two confocally operating microscopes are disposed lying opposite one another, symmetrical to the sample to be measured, which are both provided with a CCD or CMOS camera or the like, whereby the two microscopes are controlled by way of separate control electronics and a common measurement computer.

7: Device according to claim 6, wherein the microscope is based on the multi-pinhole technique, by means of a rotating Nipkow disk.

8: Device according to claim 6, wherein the microscope is based on the multi-pinhole technique, by means of a matrix of micro-mirrors.

9: Device according to claim 6, wherein the microscope is a confocal point sensor.
